(19) United States
(12) Patent Application Publication
(10) Pub. No.: US 2009/0184279 A1
(43) Pub. Date: Jul. 23, 2009

(54) WEDGE AND COVERED INSERT ASSEMBLY

(75) Inventors: Edward W. Hulse, Monroe City, MO (US); Kevin W. Pennewell, Palmyra, MO (US); Gregg A. Teel, Quincy, IL (US)

Correspondence Address: BENESCH, FRIEDLANDER, COPLAN & ARONOFF LLP;ATTN: IP DEPARTMENT DOCKET CLERK, 200 PUBLIC SQUARE, SUITE 2300, CLEVELAND, OH, 44114-2378, US

(73) Assignee: Buckhorn Rubber Products, Inc., Hannibal, MO (US)

(21) Appl. No.: 12/358,536

(22) Filed: Jan. 23, 2009

Related U.S. Application Data
(60) Provisional application No. 61/022,936, filed on Jan. 23, 2008.

(51) Int. Cl. F16K 3/12; F16K 3/30

(52) U.S. Cl. 251/367; 251/326; 251/329

(57) ABSTRACT

A partial valve assembly includes a wedge and a disk assembly that is assembled with at least one covered insert assembly and at least one O-ring. The insert assembly is covered with ethylene propylene diene monomer (EPDM) rubber or is covered with at least one of the following materials: styrene-butadiene (SBR), nitrile, neoprene rubber, adhesive backed rubber, cork, cork-rubber, Buna-n rubber, Buna-s rubber, nylon, silicon sponge rubber, fiber board, leather, natural rubber, synthetic rubber, plastic, polypropylene, polystyrene, thermoplastic elastomer (TPE), polyurethane, silicone, Teflon, urethane, and the like.

### FIELD OF INVENTION

The present application relates generally to a wedge and inserts for a resilient seat gate valve. In particular, the application relates to a wedge and covered insert assemblies for a resilient seat gate valve.

### BACKGROUND

Resilient seat gate valves are employed in the transport of clean water and other fluids. The valve gate or closure member is typically in the form of a wedge made of cast iron material and the like so as to be sufficiently rugged to be suitable for high pressure and high flow applications. In a resilient seat gate valve, the outer surface of the wedge is coated with a resilient material so as to offer a fluid-tight seal even at elevated operating pressures. The wedge of the valve is operated by turning a threaded stem so as to advance or retract the wedge within the waterway of the valve housing. Upon valve closure, the resilient material on the edge of the wedge forms a fluid-tight seal with the internal surface of the valve body. As the size of the valve increases, the complexity of handling, costs, and difficulty of applying the resilient material to the edge of the wedge increases.

### BRIEF DESCRIPTION OF THE DRAWINGS

In the accompanying drawings which are incorporated in and constitute a part of the specification, embodiments are illustrated which, together with the detailed description given below, serve to describe exemplary embodiments. It will be appreciated that the illustrated boundaries of elements (e.g. shapes, groups of shapes, or other types of elements or components) in the figures represent but exemplary boundaries. In addition, one of ordinary skill in the art will appreciate that one component may be designed as multiple components or that multiple components may be designed as one component. An element shown as an internal component of another element may be implemented as an external component and vice versa. The drawings and components therein are not to any scale. Certain components may be omitted and others shown enlarged to facilitate understanding.

FIG. 1 is a perspective view of a wedge;

FIG. 1A is a side view of the wedge of FIG. 1;

FIG. 2 is a perspective view of a covered insert assembly;

FIG. 3 is a perspective view of an exploded assembly of a wedge and a covered insert assembly;

FIG. 4 is a perspective view of a wedge assembled with two covered insert assemblies;

FIG. 5 is a partial cross-section of the upper eyebrow end of the wedge assembled with two covered insert assemblies; and

FIG. 6 is a partial cross-section of the lower nose end of the wedge assembled with two covered insert assemblies.

### DETAILED DESCRIPTION

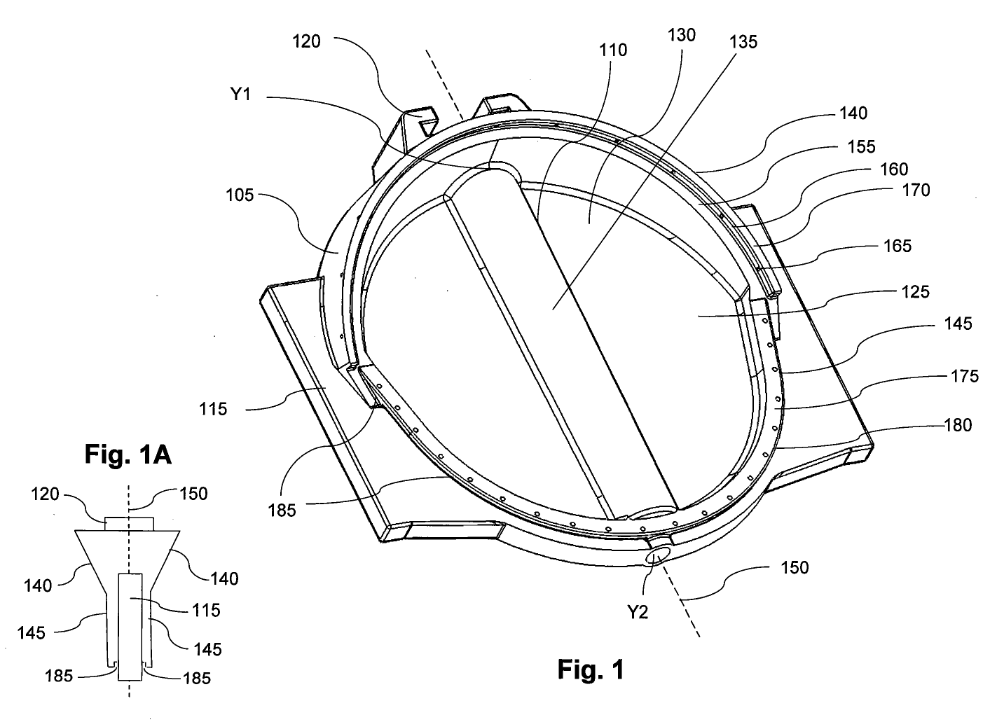

FIG. 1 shows a perspective view of one embodiment of a wedge 105 with a disk structure 110. In the illustrated embodiment, the wedge 105 is for use in a resilient seat gate valve assembly.

In the illustrated embodiment, the wedge 105 is substantially circular with at least two integrally extending tabs 115. In other embodiments (not shown), the wedge 105 is elliptical, square, rectangular, or any other geometric shape. In yet another embodiment (not shown), the integrally extending tabs 115 of the wedge 105 may include at least one of the following: grooves, slots, holes, and the like. In still other embodiments (not shown), the wedge 105 does not include integrally extending tabs 115. In the illustrated embodiment, the size of the wedge 105 corresponds with a valve body in a size range between about 2″ to about 192″, preferably from about 24″ to about 144″.

In the illustrated embodiment, the wedge 105 additionally includes a nut pocket area 120, apertures Y1 and Y2, and an inner region 125 that includes the disk structure 110. The disk structure 110 generally includes a disk 130 and a shaft 135. In one embodiment, the wedge 105 and the disk structure 110 are constructed of at least one of the following materials: cast iron, cast steel, cast bronze, steel, stainless steel, bronze, copper, plastic, and the like. The edge 105, the disk 130, and the shaft 135 may be coated with at least one of the following: powder coat paint, oil based paint, water based paint, corrosion resistant coating, and the like.

With continued reference to FIG. 1 and with further reference to FIG. 1A, showing a side view of the wedge 105, an upper eyebrow base 140 and a lower nose base 145 define the inner region 125. The wedge 105 is symmetric on each side of the inner region 125, so an upper eyebrow base 140 and a lower nose base 145 are on each side of the wedge 105. The face of the upper eyebrow base 140 and the face of the lower nose base 145 are not parallel with each other. Instead, the upper eyebrow base 140 is at an acute angle relative to all axis 150 and the lower nose base 145 is substantially parallel to the axis 150. In other embodiments (not shown), the upper eyebrow base 140 and the lower nose base 145 are substantially parallel with each other and to the axis 150. In yet other embodiments (not shown), the upper eyebrow base 140 and the lower nose base 145 are both at acute angles relative to the axis 150. In the illustrated embodiment, the upper eyebrow base 140 consists of a lower face 155, a shoulder 160 that includes a series of holes 165, and an upper face 170. In another embodiment (not shown), the shoulder 160 does not include the series of holes 165. The lower nose base 145 consists of a flat 175 that contains a series of holes 180 and a groove 185 formed from the offset of lower nose base 145 from the integrally extending tabs 115.

With further reference to FIG. 1, the shaft 135 includes an internally threaded cavity (not shown) that extends its entire length and is used to connect the wedge 105 to a valve body (not shown) or valve bonnet (not shown). The wedge 105 is connected to a valve body via an internally threaded T-nut (not shown) and a threaded shaft (not shown). For assembly, the T-bolt is first inserted into the opening of the nut pocket area 120 and then the threaded shaft is threaded through the T-bolt, the aperture Y1, and subsequently into the internally threaded cavity of the shaft 135. The nut pocket area 120 prevents the T-bolt from turning. As the threaded shaft rotates, the wedge 105, the disk structure 110, and the T-bolt raise or lower as a single unit along axis 150 within the valve body.

In operation, an actuator (not shown) may be mounted and connected to the threaded shaft (not shown) such that the wedge 105 and disk structure 110 may be manually or automatically raised and lowered along the axis 150. The actuator may be activated by an electric motor, air pressure, steam pressure, manual device, or other such means.

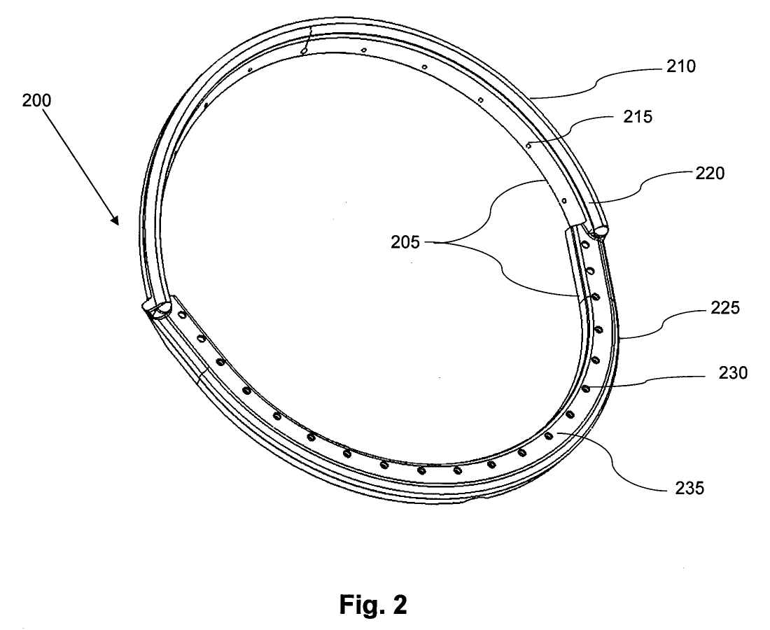

FIG. 2 shows a perspective view of a covered insert assembly 200. The covered insert assembly 200 includes an insert 205, an upper eyebrow 210 with eyebrow holes 215 and an integrally molded eyebrow covering 220, and a lower nose 225 with nose holes 230 and an integrally molded nose covering 235. In the illustrated embodiment, the face of the upper eyebrow 210 and the face of the lower nose 225 are not parallel, but have the same configuration relative to each other as the upper eyebrow base 135 and the lower nose base 140 of the wedge 105. In another embodiment (not shown), the upper eyebrow 210 and the lower nose 225 are parallel to each other and the axis 150. In yet another embodiment (not shown), the upper eyebrow 210 and the lower nose 225 are both acute to the axis 150 (axis shown in FIG. 1).

In the illustrated embodiment, the insert 205 is made of at least one of the following materials: stainless steel, painted carbon steel, plated carbon steel, copper, bronze, plastic, cast iron, and the like. In the illustrated embodiment, the eyebrow covering 220 and nose covering 235 are integrally molded onto the insert 205. In another embodiment (not shown), the eyebrow covering 220 and nose covering 235 are integrally molded onto the insert 205 and an adhesive (not shown). In another embodiment (not shown), the eyebrow covering 220 and nose covering 235 are attached to the insert 205 by at least one of the following: vulcanization, glue, epoxy, silicone, mechanical fasteners, adhesives, and the like. In yet another embodiment (not shown), the eyebrow covering 220 and nose covering 235 do not attach to the insert, but instead are held in place between the upper eyebrow 210 and lower nose 225 and an opposing valve body, pipe, duct, tube, and the like, by means of an interference fit.

In one embodiment, the eyebrow covering 220 and the nose covering 235 are composed of ethylene propylene diene monomer (EPDM) rubber. In alternative embodiments (not shown), the eyebrow covering 220 and the nose covering 235 are composed of at least one of the following: styrene-butadiene (SBR), nitrile, neoprene rubber, adhesive backed rubber, cork, cork-rubber, Buna-n rubber, Buna-s rubber, nylon, Silicon spoilage rubber, fiber board, leather, natural rubber, synthetic rubber, plastic, polypropylene, polystyrene, thermoplastic elastomer (TPE), polyurethane, silicone, Teflon, urethane, and the like.

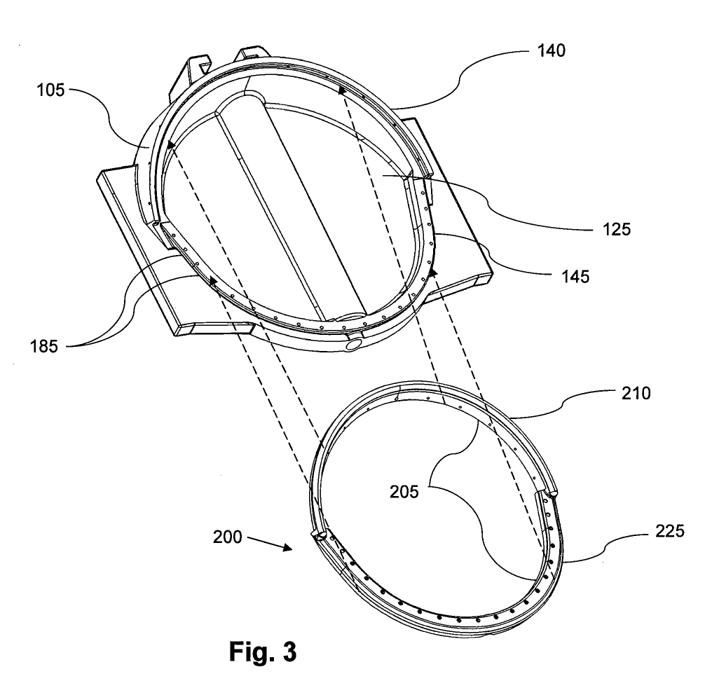

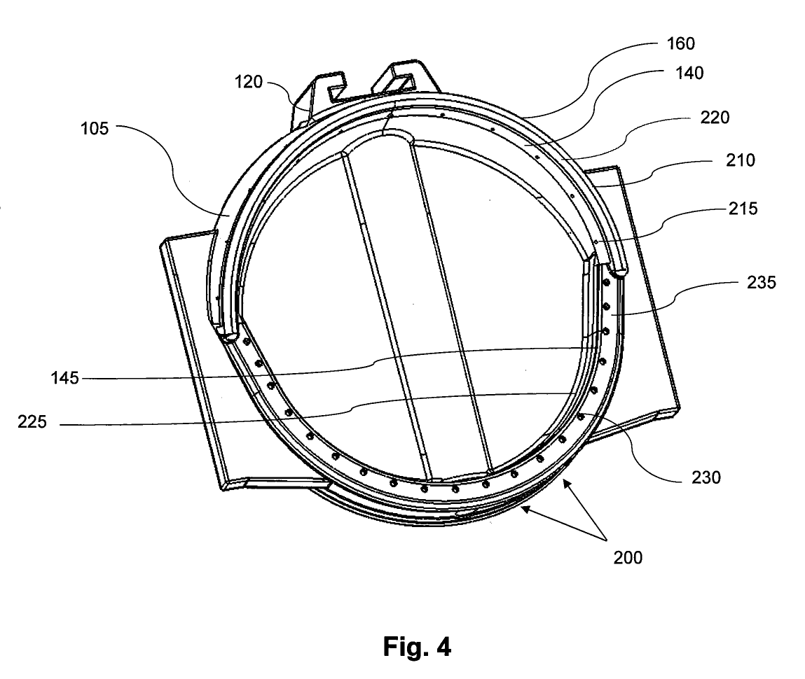

FIG. 3 shows a perspective view of an exploded assembly of a wedge 105 and a covered insert assembly 200. An alternative assembly includes a covered insert assembly 200 attached to the upper eyebrow base 140 and the lower nose base 145 on each side of the inner region 125 on the wedge 105 as shown in FIG. 4. As shown in the illustrated embodiment, an assembly may include a wedge 105 and only one covered insert assembly 200. The covered insert assembly 200 is installed on the wedge 105 by sliding the covered insert assembly 200 upward from the lower nose base 145 to the upper eyebrow base 140 so that a tip (not shown) on lower nose 225 of the insert assembly 200 fits into the groove 185 of the wedge 105.

In the complete assembly, the eyebrow covering 220 and the nose covering 235 provide a seal between the upper eyebrow 210 and the lower nose 225 of the covered insert assembly 200 when assembled with a valve body, pipe, duct, tube, or the like (not shown). Each covered insert assembly 200 fastens to the wedge 105 by mechanically connecting the upper eyebrow 210 to the shoulder 160 of the upper eyebrow base 140 and the lower nose 225 to the lower nose base 145. Additionally, the tip (not shown) of the lower nose 225 locks into the groove 185 (shown in FIG. 1) of the wedge 105. The upper eyebrow 210, the lower nose 225, and the bases are mechanically connected by aligning the eyebrow holes 215 with the series of threaded holes 165 (shown in FIG. 1) on the shoulder 160 and by aligning the nose holes 230 with the series of threaded holes 180 (shown in FIG. 1) and then securing them in place with a series of fasteners (not shown), exemplary fasteners include a screw, a threaded bolt, and the like. In other embodiments (not shown), the series of threaded holes 165 (not shown) and the series of threaded holes 180 (shown in FIG. 1) are not threaded and exemplary fasteners that may be used include a self locking pin, rivets, nuts and bolts, and the like. In still other embodiments (not shown), the covered insert assembly 200 is welded to the wedge 105.

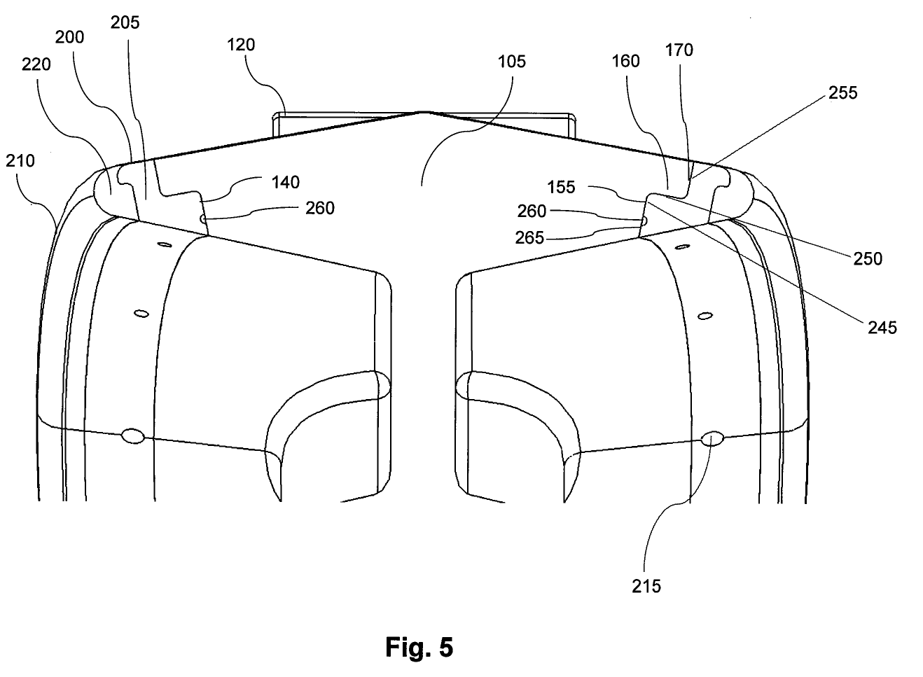

FIG. 5 is a partial cross-section of the upper eyebrow 210 of the assembled wedge 105 and covered insert assembly 200 with eyebrow covering 220. The upper eyebrow 210 section of the insert 205 has a contour consisting of an insert lower face 245, an insert shoulder 250, and an insert upper face 255 that fits with the contour of the upper eyebrow base 140 of the wedge 105. The insert lower face 245 fits with the lower face 155, the insert shoulder 250 fits with the shoulder 160, and the insert upper face 255 fits together with the upper face 170. Once fitted together, the covered insert assembly 200 is mechanically connected to the wedge 105 by fasteners (not shown) that are inserted into a series of eyebrow holes 215 in the upper eyebrow 210.

In the illustrated embodiment, an O-ring 260 fits into a groove 265 of the insert lower face 245 to maintain a seal between the wedge 105 and the insert 205. In another embodiment (not shown), the O-ring 260 is integrally molded into the groove 265. In the illustrated embodiment, the O-ring 260 is composed of ethylene propylene diene monomer (EPDM) rubber. In an alternative embodiment (not shown), the O-ring 260 is composed of at least one of the following: styrene-butadiene (SBR), nitrile, neoprene rubber, adhesive backed rubber, cork, cork-rubber, Buna-n rubber, Buna-s rubber, nylon, silicon sponge rubber, fiber board, leather, natural rubber, synthetic rubber, plastic, polypropylene, polystyrene, thermoplastic elastomer (TPE), polyurethane, silicone, Teflon, urethane, and the like.

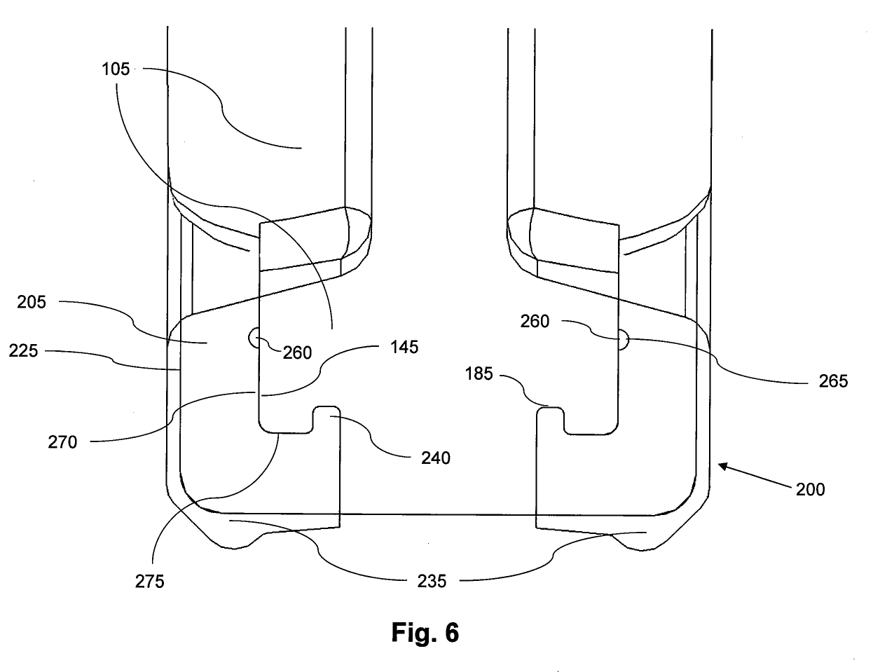

FIG. 6 is a partial cross-section of the lower nose 225 of the assembled wedge 105 with covered insert assembly 200. The lower nose 225 consists of a nose base 270 that fits against lower nose base 145 of the wedge 105, and a shoulder 275 and the tip 240 that fits into the groove 185 in the lower nose base 145 of the wedge 105. The nose base 270, the shoulder 275, and the tip 240 form a tongue and fit into the groove 185 of the lower nose base 145 to form a tongue and groove assembly that reinforces the wedge 105 and the covered insert assembly 200. In another embodiment (not shown), the lower nose 225 consists of a nose base 270 and a shoulder 275 with a molded nose covering 235. In yet another embodiment (not shown), the lower nose 225 consists of a nose base 270 with a molded nose covering 235. Once fitted together, each covered insert assembly 200 is mechanically connected to the wedge 105 by means of fasteners using a series of nose holes 230 (shown in FIG. 2) in the lower nose 225 of the covered insert assembly 200. In another embodiment (not shown), each covered insert assembly 200 is welded to the wedge 105.

In the illustrated embodiment, an O-ring 260 fits into a groove 265 of the insert nose base 270 to maintain a seal between the wedge 105 and inserts 205. In another embodiment (not shown), the O-ring 260 is integrally molded into the groove 265. In the illustrated embodiment, the O-ring 260 is composed of ethylene propylene diene monomer (EPDM) rubber. In an alternative embodiment (not shown), the O-ring 260 is composed of at least one of the following: styrene-butadiene (SBR), nitrile, neoprene rubber, adhesive backed rubber, cork, cork-rubber, Buna-n rubber, Buna-s rubber, nylon, silicon sponge rubber, fiber board, leather, natural rubber, synthetic rubber, plastic, polypropylene, polystyrene, thermoplastic elastomer (TPE), polyurethane, silicone, Teflon, urethane, and the like.

In other embodiments (not shown), the wedge 105 and covered insert assembly 200 are for use in at least one of the following valve assemblies: butterfly valve, globe valve, pinch valve, check valve, plug valve, ball valve, control valve, and the like.

While the apparatuses, systems and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the apparatuses, systems and so on provided herein. Additional advantages and modifications will readily appear to those skilled in the art. Therefore, the invention, in its broader aspects, is not limited to the specific details, the representative system or method, and illustrative examples shown and described. Accordingly, departures may be made from such details without departing from the spirit or scope of the applicant's general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Similarly, when the applicants intend to indicate “one and only one” of A, B, or C, the applicants will employ the phrase “one and only one”. Thus, use of the term “or” herein is the inclusive, and not the exclusive use.

1. A valve component apparatus comprising:
a wedge having an inner region, an upper eyebrow base, and a lower nose base wherein the inner region of the wedge has a disk and a shaft that has an internally threaded cavity;
at least one covered insert wherein the at least one covered insert has an upper eyebrow with an attached eyebrow covering and a lower nose with an attached nose covering; and
at least one O-ring;
wherein the at least one covered insert and the at least one O-ring are assembled to the wedge.
